(19) United States
(12) Patent Application Publication
(10) Pub. No.: US 2012/0202544 A1
(43) Pub. Date: Aug. 9, 2012

(54) METHOD AND APPARATUS FOR SETTING THE INITIAL TRANSMISSION POWER OF A TERMINAL IN A CELLULAR WIRELESS COMMUNICATION SYSTEM THAT SUPPORTS CARRIER AGGREGATION

(76) Inventors: Young Bum Kim, Dongdaemun-gu (KR); Joon Young Cho, Suwon-si (KR); Jin Kyu Han, Dongjak-gu (KR); Seung Hoon Choi, Suwon-si (KR); Hyoung Ju Ji, Gangnam-gu (KR)

(21) Appl. No.: 13/391,523

(22) PCT Filed: Aug. 18, 2010
(86) PCT No.: PCT/KR10/05455

§ 371 Date: Apr. 23, 2012

(30) Foreign Application Priority Data
Aug. 18, 2009 (KR) 10-2009-0076424

(51) Int. Cl. H04W 52/04; H04W 72/04; H04W 74/08

(52) U.S. Cl. 455/509; 455/522

(57) ABSTRACT

The present invention relates to a method and apparatus for setting the transmission power of a terminal in a wireless communication system. Particularly, the initial transmission power by means of which the terminal transmits a signal via an uplink non-anchor carrier is determined by reflecting the transmission power by means of which the terminal has most recently transmitted a signal via an uplink anchor carrier and by reflecting the difference between channel environments of the uplink anchor carrier and the uplink non-anchor carrier, in a wireless communication system using a broadband formed by carrier aggregation. Consequently, the initial transmission power of the terminal is set as accurately as possible in the uplink non-anchor carrier, thereby preventing signal transmission delay and improving the reliability of received signals.

### BACKGROUND OF THE INVENTION

1. Field of the Invention

The present invention relates to a cellular radio communication system and, in particular, to a method and apparatus for configuring initial transmission power of uplink non-anchor carrier of a terminal in a system supporting carrier aggregation.

2. Description of the Related Art

Recently, many researches are being conducted on the Orthogonal Frequency Division Multiple Access (OFDMA) and Single Carrier Frequency Division Multiple Access (SC-FDMA) as useful schemes for high speed data transmission over a radio channel. In such multiple access schemes, the user-specific data and/or control information are mapped to time-frequency resources without overlapped from each other, i.e. maintaining orthogonality, to identify the user-specific data and/or control information.

In a cellular communication system, one of the significant factors to provide high-speed wireless data service is bandwidth scalability for dynamic resource allocation. For example, Long Term Evolution (LTE) system can support the bandwidths of 20/15/10/5/3/1.4 MHz.

The carriers can provide services with at least one of the bandwidths, and the user equipments can have different capabilities such that some supports only 1.4 MHz bandwidth and others up to 20 MHz bandwidth. The LTE-Advanced (LTE-A) system, aiming at achieving the requirements of the IMT-Advanced service, can provide broadband service by aggregating carries up to 100 MHz.

The LTE-A system needs the bandwidth wider than that of LTE system for high-speed data transmission. Simultaneously, the LTE-A system needs to be backward compatible with the LTE system such that the LTE UEs can access the services of the LTE-Advanced system. For this purpose, the entire system bandwidth of the LTE-A system is divided into sub-bands or component carriers that have a bandwidth supporting transmission or reception of the LTE UE and can be aggregated for supporting the high speed data transmission of the LTE-A system in the transmission/reception process of the legacy LTE system per component carrier.

FIG. 1 is a diagram illustrating an example of carrier aggregation according to a convention technology.

FIG. 1 shows an example for configuring an LTE-A system with component carriers 113, 115, 117, 123, 125, and 127 that are aggregated by 3 for uplink (UL) 110 and downlink (DL) 120. One of the aggregated component carriers is referred to as anchor carrier or anchor component carrier or primary carrier. The other carriers that are not anchor carrier are referred to as non-anchor carrier or non-anchor component carrier or non-primary carrier.

In uplink 110, the component carrier on which the UE performs random access after initial system attachment can be the uplink anchor carrier. In downlink 120, the component carrier configured as the anchor carrier can be used for transmitting initial system information and uplink signaling, and the anchor carrier can be a reference component carrier for controlling UE mobility.

FIG. 1 shows an example where the uplink component carrier #0 (uplink CC #0) 113 and the downlink component carrier #0 (downlink CC#0) 123 are configured as anchor carriers in uplink 110 and downlink 120 respectively. Although FIG. 1 is directed to the case where uplink component carriers and downlink component carriers are symmetrical and equal to each other in numbers, it is possible to aggregate the uplink/downlink carriers in asymmetrical manner.

When a UE attempts initial attachment to an LTE system, the UE acquires downlink timing and frequency region synchronization through cell search and then cell ID. Afterward, the UE receives system information from the eNB to acquire basic parameter values related to transmission/reception such as system bandwidth. Next, the UE performs random access to transition to the connected state on the link with the eNB. A description is made of the random access procedure with reference to FIG. 2 hereinafter.

FIG. 2 is a signaling diagram illustrating the random access procedure of the UE according to a conventional technology.

Referring to FIG. 2, the UE performs random access to the eNB by transmitting a random access preamble at step 201 such that the eNB measures transmission delay between the UE and eNB and acquires uplink synchronization. At this time, the initial transmission power of the random access preamble is determined based on the pathloss between the UE and eNB which is measured by the UE.

The eNB transmits a Random Access Response at step 202. The random access response includes a timing adjustment command and scheduling grant. In more detail, the eNB checks the transmission delay measured at step 201 and transmits the timing adjustment command to the UE. The eNB also transmit the uplink resource information and power control command as scheduling grant.

At step 203, the UE transmits a Radio Resource Control (RRC) signal to the eNB on the uplink resource allocated at step 202. Here, the RRC signal includes uplink data having UE ID. At this time, the transmission timing and transmission power are changed according to the timing adjustment command and scheduling grant received at step 202 from the eNB.

At step 204, if it is determined that the UE has performed the random access without collision with other UEs, the eNB transmits an RRC signal including UE ID which has been received at step 203. If the RRC signal transmitted by the eNB is received, the UE determines that the random access has been completed successfully.

If it fails to receive the random access signal from the UE due to the collision with the random access signal of another UE, the eNB does not transmit data any more. If there is no data from the eNB (corresponding to step 204) for a predetermined duration, it is determined that the radon access has failed. In this case, the UE repeats the procedure from step 201. If the random access is successful, the UE configures the initial transmission power of the uplink data channel or control channel by referencing the UE transmission power controlled through the random access process.

In the LTE-A system supporting carrier aggregation, however, if the UE attempts initial transmission of uplink signal on an uplink non-anchor carrier after performing the above random access process on the uplink anchor carrier, there is a need of a solution for how to configure the UE's initial transmission power. That is, there is a need of a method for configuring transmission power of data or control channel for the UE which has performed the random access only on the uplink anchor carrier but not on the uplink non-anchor carriers.

### SUMMARY OF THE INVENTION

### Problem to be Solved

In order to solve the above problems, the present invention provides a method and apparatus for configuring initial transmission power of uplink transmission channel of the UE in a wireless communication system supporting broadband transmission through carrier aggregation.

### Means for Solving the Problem

In order to achieve the above object, the initial transmission power configuration method according to an embodiment of the present invention includes configuring, when a random access process is completed on the anchor carrier, initial transmission power of the non-anchor carrier using most recent transmission power of the anchor carrier and transmitting data at the initial transmission power of the non-anchor carrier.

In order to achieve the above object, the initial transmission power configuration apparatus according to an embodiment of the present invention includes a receiver which receives a scheduling grant transmitted by a base station; a carrier aggregation controller which determines a component carrier for transmitting data based on the scheduling grant; a power control controller which configures, when the component carrier is a non-anchor carrier, initial transmission power of the non-anchor carrier using most recent transmission power of an anchor carrier; and a transmitter which transmits the data at the configured initial transmission power on the non-anchor carrier.

### Advantageous effects

The present invention configures the initial transmission power of the UE on the uplink non-anchor carrier accurately so as to avoid transmission delay and radio resource waste caused by the so lowly configured transmission power and mitigate interference caused by so highly configured transmission power.

### BRIEF DESCRIPTION OF THE DRAWINGS

FIG. 1 is a diagram illustrating an example of carrier aggregation according to a convention technology.

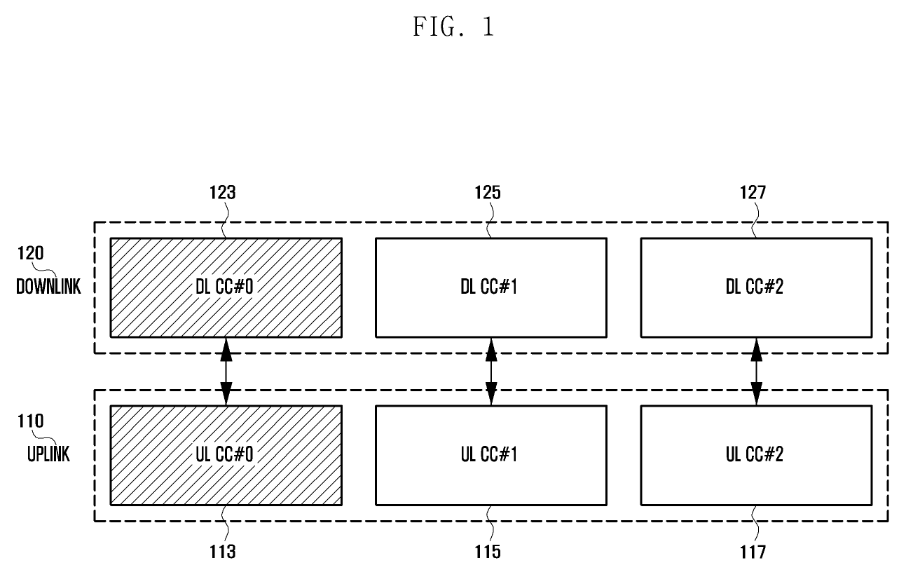

FIG. 2 is a signaling diagram illustrating the random access procedure of the UE according to a conventional technology.

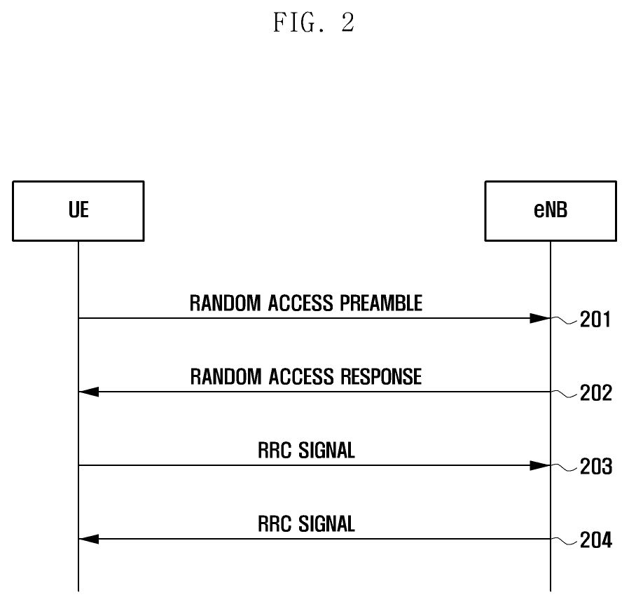

FIG. 3 is a flowchart illustrating a UE procedure for transmitting initial signal on the non-anchor carrier according to the present invention.

FIG. 4 is a diagram illustrating a method for the UE to determine transmission power of the signal transmitted initially on the non-anchor carrier according to the present invention.

FIG. 5 is a flowchart illustrating a UE procedure for receiving initial signal on the non-anchor carrier according to the present invention.

FIG. 6 is diagram illustrating a UE apparatus according to the first embodiment.

FIG. 7 is a diagram illustrating an eNB apparatus according to the first embodiment.

FIG. 8 is a diagram illustrating a UE apparatus according to the second embodiment.

FIG. 9 is a diagram illustrating a UE apparatus according to the third embodiment of the present invention.

### DETAILED DESCRIPTION OF EXEMPLARY EMBODIMENTS

Exemplary embodiments of the present invention are described with reference to the accompanying drawings in detail. Detailed description of well-known functions and structures incorporated herein may be omitted to avoid obscuring the subject matter of the present invention. In addition, terms used in the following description of the present invention are prepared in view of functions thereof, so they will be changed depending on the intention of users, operators, or custom. Thus, definition of the terms must be determined based on the whole content of the specification.

Although the description is directed to the Advanced E-UTRA (or LTE-A) supporting carrier aggregation in the following embodiments of the present invention, it will be understood by those skilled in the art that the present invention can be applied to other communication systems supporting the similar technical background and channel format with a slight modification without departing from the spirit and scope of the invention. For example, the subject matter of the present invention can be applied to multicarrier HSPA supporting carrier aggregation.

The subject matter of the present invention is to provide a method and apparatus for configuring initial transmission power of uplink transmission channels of a UE in a radio communication system supporting broadband service with carrier aggregation. Particularly, according to the present invention, the UE can configure the initial transmission power of the data or control channel by reflecting the current channel state as far as possible on the uplink non-carrier carrier for which no random access is performed. For this, the UE determines the initial transmission power of the non-anchor carrier by reflecting the transmission power of the signal transmitted by the UE most recently on the uplink anchor carrier and difference between channel environments of the uplink anchor and non-anchor carriers.

In the present invention, the uplink anchor carrier means at least one uplink component carrier on which the UE has performed random access for initial attachment among the aggregated uplink component carriers. The uplink non-anchor carrier means the other aggregated uplink component carriers with the exception of the uplink anchor carrier.

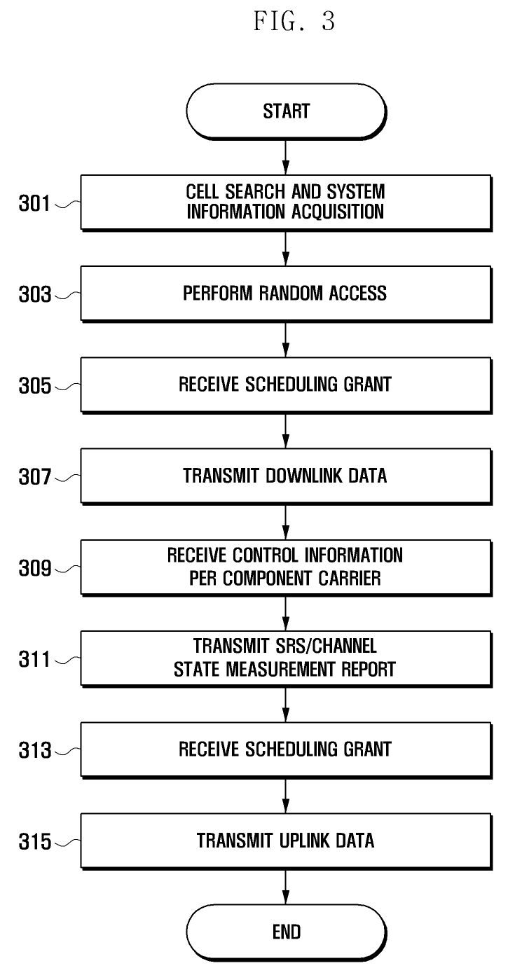

A description is made of the data or control channel transmission procedure of the UE on a uplink non-anchor carrier with reference to FIG. 3. FIG. 3 is a flowchart illustrating a UE procedure for transmitting initial signal on the non-anchor carrier according to the present invention.

Referring to FIG. 3, the UE first performs cell search and acquires system information at step 301. That is, the UE acquires downlink timing and frequency synchronization through cell search and obtains cell ID. The UE receives system information from the eNB to acquire basic parameter values related to transmission/reception such as system bandwidth.

Afterward, the UE performs random access at step 303. That is, the UE establishes a link with the eNB through the random access on the anchor carrier to transition to a connected state. In the connected state, the eNB can the UE with unique UE parameters. The UE acquires the parameter information from the eNB and uses the parameters in transmission/reception procedure. In the random access process, the UE adjusts the transmission power to an appropriate value according to the power control of the eNB.

Afterward, the UE acquires scheduling grant for uplink anchor carrier (or primary UL CC) from the eNB at step 305. The UE prepares uplink data transmission on the anchor carrier with the scheduling grant. Next, the UE transmits uplink data on the anchor carrier according to the scheduling grant at step 307. At this time, the transmission power of the uplink data which is transmitted initially by the UE is calculated based on the power level controlled in the random access process of step 303. As the data or control information transmission/reception is repeated, the UE adjusts the transmission power of the uplink anchor carrier to an appropriate value based on the uplink power control command transmitted by the eNB.

The eNB determines the uplink power control based on the channel environment between UE and eNB on the anchor carrier and scheduling grant for the UE as follows.
channel environment: Pathloss, interference amount
scheduling grant: MCS (modulation and coding scheme), scheduled resource amount

If it is determined that the UE supports carrier aggregation, the eNB transmits the detailed configuration information on the component carriers to the UE. The UE acquires the control information per component carrier (i.e., control information of multiple CCs) from the signaled information at step 309. The control information per component carrier includes number of component carriers, frequencies of the component carriers, interference amount per component carrier, and transmission power of Reference Signal (RS) per component carrier which is used for the UE to measure pathloss. If the UE transitions to the connected state, the eNB can check whether the UE supports carrier aggregation based on the signaling information of UE capability. Accordingly, step 309 can be performed at a certain time point after the UE has completed the random access process at step 303.

Afterward, the eNB requests the UE to transmit Sounding Reference Signal (SRS) and channel state measurement report necessary for scheduling the UE on non-anchor carriers. The UE transmits the SRS or channel state measurement report on the non-anchor carrier at step 311. At this time, the UE transmits to the eNB the SRS to the eNB or transmits the channel state measurement report on data channel through higher layer signaling or control channel through physical layer signaling.

The data channel or control channel for SRS or channel state measurement report is the signal for the UE to transmit signals first on the non-anchor carrier such that no reference for configuring initial transmission power level. Accordingly, the UE calculates the initial transmission power of the non-anchor carrier using the most recent transmission power of the anchor carrier. In case of anchor carrier, the transmission power level is in stable state through the power control in the random access and data channel/control channel transmission/reception process such that the UE transmission power on the anchor carrier can be referenced to configure the UE's initial transmission power level on the non-anchor carrier. In the present invention, once the random access process has completed, the initial transmission power of the non-anchor carrier is configured based on the most recent transmission power of the anchor carrier. Since the pathloss, interference amount, and scheduling grant may vary depending on the carrier, it is necessary to compensate for these additionally. The UE can compensate the initial transmission power of the non-anchor carrier using equation 1.

P(k)=P(0)+P_offset(1)+P_offset(2) Equation 1

Here, P(k) denotes initial transmission power level of UE's non-anchor carrier, P(0) denotes the most recent transmission power level of UE's anchor carrier, P_offset(1) denotes channel environment offset, and P_offset(2) denotes scheduling information offset.

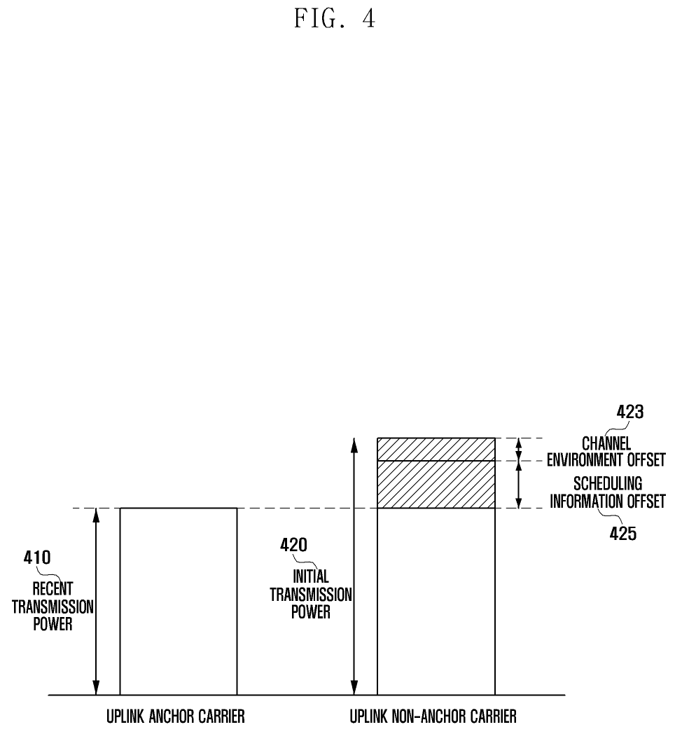

The channel environment offset includes pathloss difference and interference difference between the anchor carrier and non-anchor carrier. The scheduling information offset includes MCS difference and scheduled resource amount difference between the anchor and non-anchor carriers. The recent transmission power level of the anchor carrier and the calculated initial transmission power level of the non-anchor carrier are described with reference to FIG. 4.

FIG. 4 is a diagram illustrating a method for the UE to determine transmission power of the signal transmitted initially on the non-anchor carrier according to the present invention.

Referring to FIG. 4, it is shown that the most recent transmission power level of the UE for the anchor carrier P(0) 410 has a difference as much as the sum of the channel environment offset P_offset(1) 423 and the scheduling information offset P_offset(2) as compared to the initial transmission power of the UE for non-anchor carrier P(k) 420.

The UE performs initial transmission on the non-anchor carrier at the transmission power calculated according to equation 1. Next, the UE performs power control process according to the power control command from the eNB based on the transmission power level used for initial transmission on the non-anchor carrier.

Returning to FIG. 3, the eNB performs scheduling the UE on the data or control channel for SRS or channel state measurement report of the UE. Next, the UE acquires the scheduling grant from the eNB at step 313. Next, the UE transmits data on the non-anchor carrier according to the acquired scheduling information.

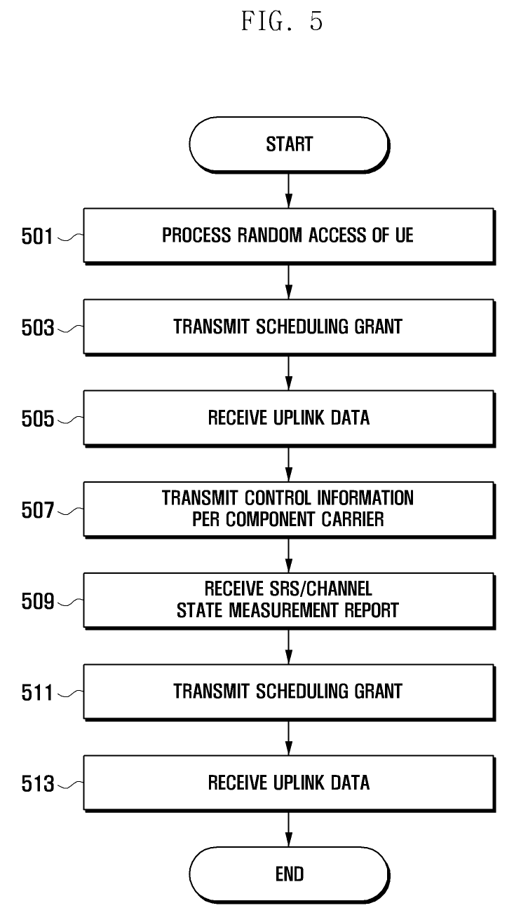

A description is made of the eNB procedure for data transmission on the non-anchor carrier with reference to FIG. 5. FIG. 5 is a flowchart illustrating a UE procedure for receiving initial signal on the non-anchor carrier according to the present invention.

Referring to FIG. 5, the eNB first performs the random access process triggered by a UE at step 501. Once the random access process has completed, the link between the eNB and the UE transitions from idle state to connected state. In connected state, the eNB can configures the UE with unique parameters necessary for transmission/reception of the UE. In the random process, the eNB adjusts the transmission power of the UE to an appropriate value through power control.

The eNB transmits a scheduling grant for uplink anchor carrier (or primary UL CC) to the UE at step 503. Next, the eNB receives the uplink data which the UE transmits on the anchor carrier according to the scheduling grant at step 505. As the data or control information transmission/reception continues, the eNB adjusts the uplink transmission power of the UE to an appropriate value with uplink power control.

If it is determined that the UE supports a plurality of component carriers, the eNB signals detailed configuration information on the individual component carriers to the UE at step 507. At this time, the eNB requests the UE to transmit SRS (sounding reference signal) or channel state measurement report for scheduling the UE. Step 507 can be performed at a certain time point after the UE completes the random access procedure at step 501.

Next, the eNB receives the SRS/channel state measurement report transmitted by the UE at step 509. The eNB generates scheduling grant for the UE on the non-anchor carrier based on the information acquired at step 509 and transmits the scheduling grant to the UE at step 511. Next, the eNB receives the data which the UE transmits on the non-anchor carrier at step 513.

The present invention can be applied to a plurality component carriers aggregated for broadband without restriction.

A description is made of the initial transmission power configuration of uplink transmission channel of the UE on the non-anchor carrier.

### First Embodiment

The first embodiment describes a method for configuring initial transmission power of Physical Uplink Shared Channel (PUSCH) when the signal which the UE transmits first on the non-anchor carrier is PUSCH in the LTE-A system. The signal transmitted on the PUSCH can be data or higher layer signaling information.

The PUSCH transmission power in i^{th} frame on k^{th} component carrier is determined by equation 2.

P_{PUSCH}(i, k)=min{P_{CMAX}, 10 log₁₀(M_{PUSCH}(i,k))+P_{O}_{_{—}}_{PUSCH}(j,k)+αα(j,k)·PL(k)+Δ_{TF}(i,k)+f(i,k)} Equation 2
P_{CMAX}: maximum allowed UE transmission power which is determined depending on the UE class and higher layer signaling configuration.
M_{PUSCH}(i,k): a number of Physical Resource Blocks (PRB) as resource amount scheduled by the eNB in i^{th} subframe on k^{th} component carrier.
P_{O}_{_{—}}_{PUSCH}(j,k): interference amount which is measured by the eNB on the k^{th} component carrier and signaled to the UE, where index j is set to a value according to the type of data to be scheduled, i.e. j=1 for the semi-persistent scheduling data for which the scheduling grant is valid for a predetermined duration, j=2 for the dynamic scheduling data, and j=3 for the uplink data in the random access process.
α(j,k): value for partially compensating pathloss between eNB and UE on k^{th} component carrier. 0≦α(j,k)≦1
PL(k): pathloss between eNB and UE on k^{th} component carrier, the UE calculates pathloss based on the difference between the transmission power of the RS signaled by the eNB and received signal level of the RS.
Δ_{TF}(i,k): power offset according to the transport format (TF) of the data scheduled by the eNB in iₜₕ subframe on kₜₕ component carrier.
f(i,k): calculated based on the power control command included in the eNB scheduling information in i^{th} subframe on k^{th} component carrier.

That is, equation 2 shows that the transmission power of the UE is determined based on the channel environment compensation parameter (P_{O}_{_{—}}_{PUSCH}(j,k), α(j,k), PL(k)), α(j,k), (M_{PUSCH}(i,k), Δ_{TF}(i,k)) according to PL(k) and scheduling information, and additional compensation f(i,k). The parameter for compensating the channel environment is configured in semi-static manner and signaled to the UE. The parameter according to scheduling information and the additional compensation are relatively dynamic variables calculated from the eNB scheduling information in i^{th} subframe.

If the uplink anchor carrier index of k=0, the initial PUSCH transmission power on the uplink anchor carrier (k≠0) is obtained by applying the initial value of f(i,k) defined as equation 3 to equation 2.

f(i,k)=P_{PUSCH}(i, 0)−10 log₁₀(M_{PUSCH}(i,0))−P_{O}_{_{—}}_{PUSCH}(j,0)−α(j,0)·PL(0)−Δ_{TF}(i,0) Equation 3

In equation 3, P_{PUSCH}(i, 0) denotes PUSCH transmission power of the UE in i^{th} subframe on the anchor carrier and, if there is no PUSCH transmitted in the i^{th} subframe on the anchor carrier, the transmission power of PUSCH transmitted most recently on the anchor carrier is referenced.

The initial value of f(i,k) on the non-anchor carrier expressed by equation 3 is the initially applied value which is calculated with the power control command from the eNB after PUSCH is transmitted once when the signal transmitted by the UE first on the non-anchor carrier is PUSCH.

Equation 4 is of the value calculated by applying equation 3 to equation 2 as the initial PUSCH transmission power when the first signal transmitted by the UE on the non-anchor carrier is PUSCH.

P_{PUSCH}(i, k)=min{P_{CMAX}, P_{PUSCH}(i, 0)+10 log₁₀(M_{PUSCH}(i,k)/M_{PUSCH}(i,0))+P_{O}_{_{—}}_{PUSCH}(j,k)−P_{O}_{_{—}}_{PUSCH}(j,0)+α(j,k)·PL(k)−α(j,0)·PL(0)+Δ_{TF}(i,k)−Δ_{TF}(i,0)} Equation 4

As a result, equation 4 shows that the UE's initial transmission power on the non-anchor carrier is calculated with the UE's most recent transmission power level on the anchor carrier, channel environment difference between anchor and non-anchor carriers, and scheduling information difference between the anchor and non-anchor carriers, as described with reference to equation 1.

As a modification from the first embodiment, it can be considered to perform random access process on the non-anchor carrier when the UE is transmitting a signal on the non-anchor carrier first. That is, the transmission power of the UE is adjusted to a certain level appropriate for the channel environment through power control in random access on the non-anchor carrier. The adjusted transmission power can be used as reference power level for signals to be transmitted after the random access process. If the initial transmission power of uplink signal in the UE's random access on the non-anchor carrier is determined by equation 1, it is possible to perform relatively accurate power control.

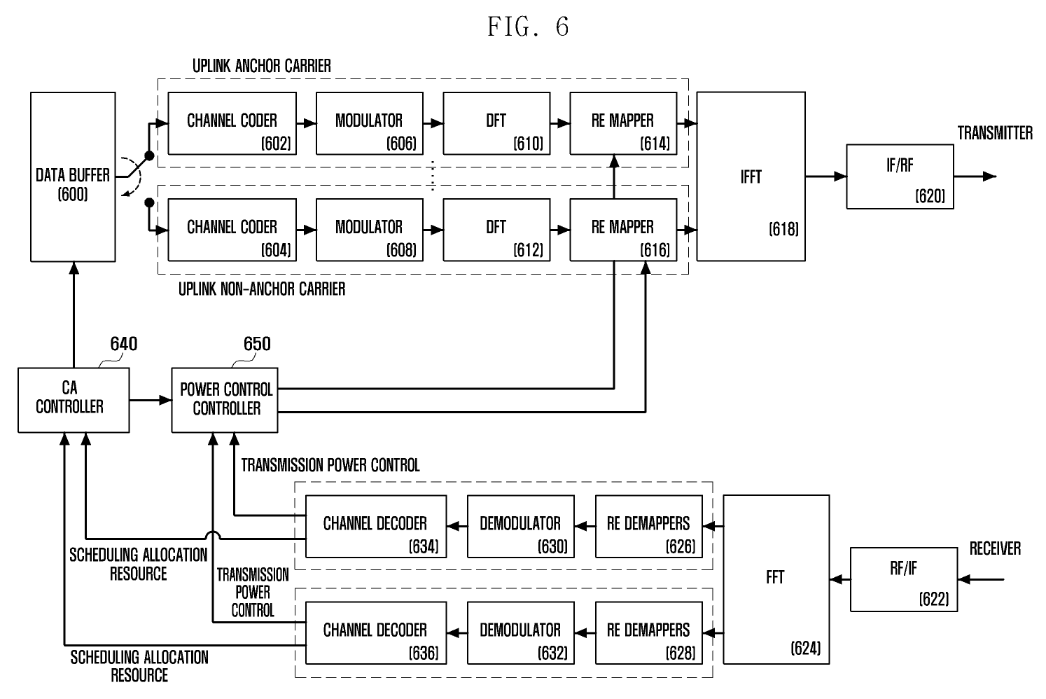

FIG. 6 is diagram illustrating a UE apparatus according to the first embodiment. FIG. 6 shows an exemplary UE apparatus operating with two aggregated component carriers in uplink.

For uplink transmission, the transmitter of the UE includes a data buffer 600 for buffering data, channel coders 602 and 604 for providing error correction capability to the data transmitted on the respective component carriers, modulation mappers 606 and 608 generating modulation symbols, Discrete Fourier Transform (DFT) units 610 and 612 for performing Discrete Fourier Transform, and Resource Element (RE) mappers 614 and 616 for mapping the DFT outputs to REs. The signals output from the RE mappers 614 and 616 for the respective component carriers are transmitted through Inverse Fast Fourier Transform (IFFT) unit 618 and Intermediate Frequency (IF)/Radio Frequency (RF) processor 620. Although the IFFT unit 618 and IF/RF unit 620 are depicted common functional blocks in FIG. 6, they can be implemented as individual function blocks responsible for respective component carriers.

The transmitter of the UE includes an RF/IF unit 622 for processing received RF/IF signals, FFT unit 624 for performing FFT, RE demappers 626 and 628 for demapping REs, demodulators 630 and 632, and channel decoders 634 and 636. The RF/IF unit 622 and FFT unit 624 can be implemented per component carrier.

The carrier aggregation controller 640 determines the component carriers to perform data transmission in uplink based on the scheduling grant received from the eNB through the UE receiver. The carrier aggregation controller 640 controls the data buffer 600 to transfer the data to the uplink component carrier processor to be used according to the determination result. The carrier aggregation controller 640 controls the power control controller 650 to perform power control on the component carriers.

The power control controller 650 performs power control on the corresponding component carrier based on the control command of the carrier aggregation controller 640 and the Transmit Power Control (TPC) command received through the UE receiver. Although the power control performed by the power control controller 650 is applied to the RE mappers 614 and 616 for the respective component carriers, it can be implemented to apply the power control to other function blocks such as modulators 606 and 608. In case that the signal transmitted first on the non-anchor carrier of the UE is PUSCH, the power control controller 650 can perform the power control such that the initial transmission power of PUSCH is configured by equation 4. Once PUSCH has been transmitted on the non-anchor carrier, the power control controller 650 performs power control according to the power control command from the eNB.

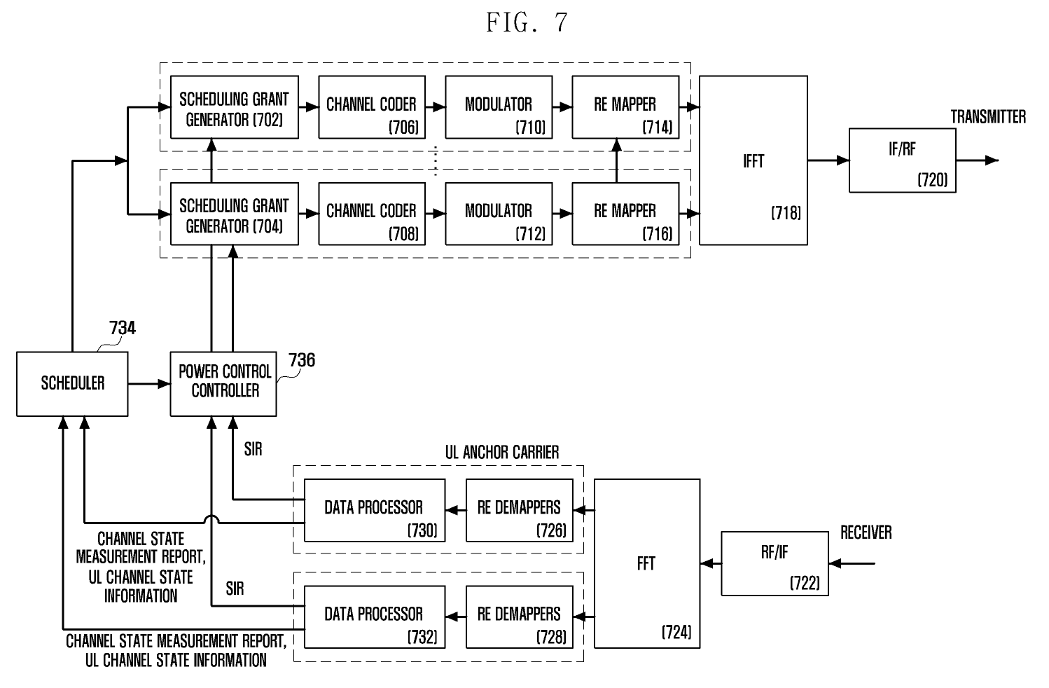

FIG. 7 is a diagram illustrating an eNB apparatus according to the first embodiment. The eNB includes an RF/IF unit 722 for processing the signal received from the UE, a Fast Fourier Transform (FFT) unit 724 for performing FFT, Resource Element (RE) demappers 726 and 728 for RE demapping on the respective component carriers, and data processors (Physical Uplink Shared Channel (PUSCH)/Physical Uplink Control Channel (PUCCH)/Sounding Reference Signal (SRS) processors) 730 and 732. The RF/IF unit 722 and FFT unit 724 can be implemented per component carrier. The data processor 730 includes a decoder and demodulator for processing signal according to the type of the signal transmitted by the UE.

The eNB scheduler 734 acquires channel state measurement report and uplink channel state information (CSI) from the receiver and determines the component carrier for scheduling the UE thereon and the transmission format and provides the determination result to the scheduling information generators 702 and 704 for the corresponding component carriers. The UE scheduler 734 provides the eNB power control controller 736 with information on the component carrier on which the UE is scheduled.

The power control controller 736 receives Signal-to-Interference (SIR) measurement values of the received signals from the receiver to generate power control commands for the individual uplink component carriers and provides the power control commands to the scheduling grant generators 702 and 740 for the respective component carriers. The control signals generated by the scheduling grant generators 702 and 704 are processed by the channel coders 706 and 708, the modulation mapper 710 and 712, and the RE mappers 714 and 716, transformed by the IFFT unit 718, and then signal-processed by the IF/RF unit 720 to be transmitted to the UE. The RF/IF unit 720 and IFFT unit 718 can be implemented per component carrier.

### Second Embodiment

The second embodiment proposes a method for configuring initial transmission power of PUCCH when the signal transmitted first by the UE on the non-anchor carrier is Physical Uplink Control Channel (PUCCH) carrying control information in uplink. The signal carried in the PUCCH can be ACK/NACK for downlink data or Channel Quality Indicator (CQI) information indicating downlink channel state.

The PUCCH transmission power in i^{th} subframe on k^{th} component carrier is determined by equation 5.

P_{PUCCH}(i, k)=min{P_{CMAX}, P_{O}_{_{—}}_{PUCCH}(k)+PL(k)+h(n_{CQI}, n_{HARQ}, k)+Δ_{F}_{_{—}}_{PUCCH}(F,k)+g(i,k) Equation 5
PCMAX: maximum allowed UE transmission power which is determined depending on the UE class and higher layer signaling configuration.
P_{O}_{_{—}}_{PUCCH}(k): interference amount which is measured by the eNB on the k^{th} component carrier and signaled to the UE.
PL(k): pathloss between eNB and UE on k^{th} component carrier, the UE calculates pathloss based on the difference between the transmission power of the RS signaled by the eNB and received signal level of the RS.
h(n_{CQI}, n_{HARQ}, k): offset determined according to the CQI information amount when the control information of PUCCH to be transmitted by the UE on k^{th} component carrier is CQI.
Δ_{F}_{_{—}}_{PUCCH}(F,k): offset determined depending on whether the control information of PUCCH to be transmitted by the UE on the k^{th} component carrier is ACK/NACK or CQI.
g(i,k): calculated according to the power control command included in the eNB's scheduling information in i^{th} subframe on k^{th} component carrier.

That is, equation 5 shows that the transmission power of the UE is determined based on the channel environment compensation parameter (P_{O}_{_{—}}_{PUCCH}(k), PL(k)), (h(n_{CQI}, n_{HARQ}, k), _{F}_{_{—}}_{PUCCH}(F,k)) according to the type of control information to be transmitted by the UE based on the eNB's scheduling, and the additional compensation (g(i,k)). The parameter for compensating the channel environment is configured in semi-static manner and signaled to the UE.

If the uplink anchor carrier index of k=0, the initial PUCCH transmission power on the uplink anchor carrier (k∫0) is obtained by applying the initial value of g(i,k) defined as equation 6 to equation 5.

g(i,k)=P_{PUCCH}(i, 0)−P_{O}_{_{—}}_{PUCCH}(j,0)−PL(0)−h(n_{CQI}, n_{HARQ}, 0)−Δ_{F}_{_{—}}_{PUCCH}(F,0) Equation 6

In equation 6, P_{PUCCH}(i,0) denotes PUCCH transmission power in iₜₕ subframe on the anchor carrier and, if there is no PUCCH transmitted in the iₜₕ subframe on the anchor carrier, the transmission power of PUCCH transmitted most recently on the anchor carrier is referenced.

The initial value of g(i,k) on the non-anchor carrier expressed by equation 6 is the initially applied value which is calculated with the power control command from the eNB after PUCCH is transmitted once when the signal transmitted by the UE first on the non-anchor carrier is PUCCH.

Equation 7 has the value calculated by applying equation 6 to equation 5 as the initial PUCCH transmission power when the first signal transmitted by the UE on the non-anchor carrier is PUCCH.

P_{PUCCH}(i, k)=min{P_{CMAX}, P_{PUCCH}(i, 0)+P_{O}_{_{—}}_{PUCCH}(j,k)−P_{O}_{_{—}}_{PUCCH}(j,0)+PL(k)−PL(0)+h(n_{CQI}, n_{HARQ}, k)−h(n_{CQI}, n_{HARQ}, 0)+Δ_{F}_{_{—}}_{PUCCH}(F,k)−Δ_{F}_{_{—}}_{PUCCH}(F,0)} Equation 7

As a result, equation 7 shows that the UE's initial transmission power on the non-anchor carrier is calculated with the UE's most recent transmission power level on the anchor carrier, channel environment difference between anchor and non-anchor carriers, and scheduling information difference between the anchor and non-anchor carriers, as described with reference to equation 1.

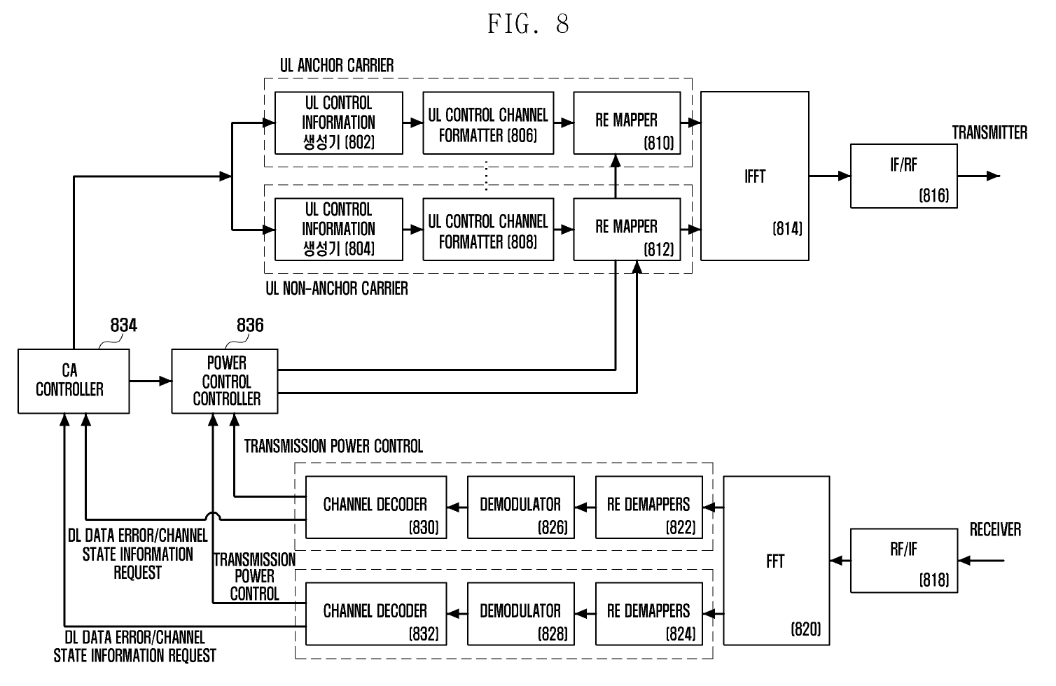

FIG. 8 is a diagram illustrating a UE apparatus according to the second embodiment. FIG. 8 shows an exemplary UE apparatus operating with two aggregated component carriers in uplink. For uplink transmission, the transmitter of the UE includes UCI generators 802 and 804 for generating uplink control information (UCI) to be transmitted on the respective component carriers, PUCCH formatters 806 and 808 for performing channel coding and modulation in match with the PUCCH transmission format, and RE mappers 810 and 812 for mapping the signal to be transmitted to Resource Elements (RE).

The signals output from the RE mappers 810 and 812 for the respective component carriers are processed by the IFFT unit 814 and then transmitted through the Intermediate Frequency (IF)/Radio Frequency (RF) processor 816. Although the IFFT unit 814 and IF/RF unit 816 are depicted common functional blocks in FIG. 8, they can be implemented as individual function blocks responsible for respective component carriers.

The receiver of the UE includes an RF/IF unit 818 for performing RF/IF processing on the received signal, a Fast Fourier Transform (FFT) unit 820, and RE mappers 822 and 824, modulation demappers 826 and 828, and decoders 830 and 832 implemented for the respective component carriers. The RF/IF unit 818 and FFT 820 also can be implemented per component carrier.

The carrier aggregation controller 834 receives the ACK/NACK for downlink data or CQI transmission request information from the UE receiver to determine the uplink component carrier for ACK/NACK or CQI transmission. The carrier aggregation controller 834 controls the UCI generators 802 and 804 to generate UCI to be transmitted on the determined uplink component carrier. The carrier aggregation controller 834 also controls the power control controller 836 to determine the component carrier to be power-controlled.

The power control controller 836 performs power control on the corresponding component carrier based on the control command of the carrier aggregation controller 834 and the Transmit Power Control (TPC) command received through the UE receiver. Although the power control performed by the power control controller 834 is applied to the RE mappers 810 and 812 for the respective component carriers in FIG. 8, it can be implemented to apply the power control to other function blocks such as modulators in the PUCCH formatters 806 and 808. In case that the signal transmitted first on the non-anchor carrier of the UE is PUCCH, the power control controller 836 can perform the power control such that the initial transmission power of PUCCH is configured by equation 7. Once PUCCH has been transmitted on the non-anchor carrier, the power control controller 836 performs power control according to the power control command from the eNB.

The eNB apparatus according to the second embodiment can be implemented in the same configuration as the eNB described with reference to FIG. 7. A brief description is made as follows.

The eNB includes an RF/IF unit for the RF/IF signal processing on the signals received from UEs, the FFT unit for perming FFT process, the RE demappers for the respective component carriers, and the PUSCH/UCCH/SRS processor. The eNB further includes an eNB scheduler for generating scheduling grant to the UE and scheduling information generator per component carrier for generating control information. The eNB performs channel coding, modulation, and RE mapping, IFFT signal processing, and IF/RF signal processing on the control information generated by the scheduling grant generator, and transmits the processed signal to the UE. The RF/IF unit and IFFT unit can be implemented per component carrier.

### Third Embodiment

The third embodiment describes a method for configuring initial SRS transmission power when the first signal transmitted by UE on the non-anchor carrier is Sounding Reference Signal (SRS) in the LTE-A system. SRS is used for the eNB to measure uplink channel state.

The SRS transmission power in i^{th} subframe on k^{th} component carrier is determined by equation 8.

P_{SRS}(i, k=min{P_{CMAX},P_{SRS}_{_{—}}_{OFFSET}(j,k)+10 log₁₀(M_{SRS}(k))+P_{O}_{_{—}}_{PUSCH}(j,k)+α(j,k)·PL(k)+f(i,k)} Equation 8
P_{CMAX}: maximum allowed UE transmission power which is determined depending on the UE class and higher layer signaling configuration.
P_{SRS}_{_{—}}_{OFFSET}(j,k): SRS power control offset for k^{th} component carrier transmitted from the eNB to the UE.
(M_{SRS}(k): bandwidth for transmitting SRS on k^{th} component carrier which is expressed by a number of PRBs.
P_{O}_{_{—}}_{PUSCH}(j,k): interference amount which is measured by the eNB on the k^{th} component carrier and signaled to the UE, where index j is set to a value according to the type of data to be scheduled, i.e. j=1 for the semi-persistent scheduling data for which the scheduling grant is valid for a predetermined duration, j=2 for the dynamic scheduling data, and j=3 for the uplink data in the random access process.
α(j,k): value for partially compensating pathloss between eNB and UE on k^{th} component carrier. 0≦α(j,k)≦1
PL(k): pathloss between eNB and UE on k^{th} component carrier, the UE calculates pathloss based on the difference between the transmission power of the RS signaled by the eNB and received signal level of the RS.
f(i,k): calculated based on the power control command included in the eNB scheduling information in i^{th} subframe on k^{th} component carrier.

That is, equation 8 shows that the SRS transmission power of the UE is determined based on the channel environment compensation parameter (P_{O}_{_{—}}_{PUSCH}(k), α(j,k), (P_{SRS}_{_{—}}_{OFFSET}(j,k), M_{SRS}(k)), SRS-related parameter (M_{PUSCH}(i,k), Δ_{TF}(i,k)) transmitted according to eNB scheduling, and additional compensation f(i,k).

If the uplink anchor carrier index is k=0, the initial value of the SRS transmission power on the uplink non-anchor carrier (k≠0) is obtained by applying the initial value of f(i,k) defined by equation 9 to equation 8.

f(i,k=P_{SRS}(i 0)−P_{SRS}_{_{—}}_{OFFSET}(j,0)−10 log₁₀(M_{SRS}(0))−P_{O}_{_{—}}_{PUSCH}(j,0)−α(j,0)·PL(0 Equation 9

In equation 9, P_{SRS}(i,0) is SRS transmission power of the UE in i^{th} subframe on the anchor carrier and, if there is no SRS transmission in i^{th} subframe on the anchor carrier, the transmission power of the SRS transmitted most recently on the anchor carrier is referenced.

The initial value of f(i,k) on the non-anchor carrier which is expressed by equation 9 is the value applied first when the first signal transmitted the UE on the non-anchor carrier is SRS and, once SRS is transmitted, calculated based on the power control command from the eNB.

Equation 10 is of the value obtained by reflecting equation 9 to equation 8 and indicates the initial transmission power of SRS when the signal transmitted first by the UE on the non-anchor carrier is SRS.

P_{SRS}(i, k)=min{P_{CMAX},P_{SRS}(i,0)+P_{SRS}_{_{—}}_{OFFSET}(j,k)−P_{SRS}_{_{—}}_{OFFSET}(j,0)+10 log₁₀(M_{SRS}(k)/M_{SRS}(0))+P_{O}_{_{—}}_{PUSCH}(j,k)−P_{O}_{_{—}}_{PUSCH}(j,0)+(j,k)·PL(k)−αα(j,0)·PL(0)} Equation 10

As a result, equation 10 shows that the UE's initial transmission power on the non-anchor carrier is calculated with the UE's most recent transmission power level on the anchor carrier, channel environment difference between anchor and non-anchor carriers, and scheduling information difference between the anchor and non-anchor carriers, as described with reference to equation 1.

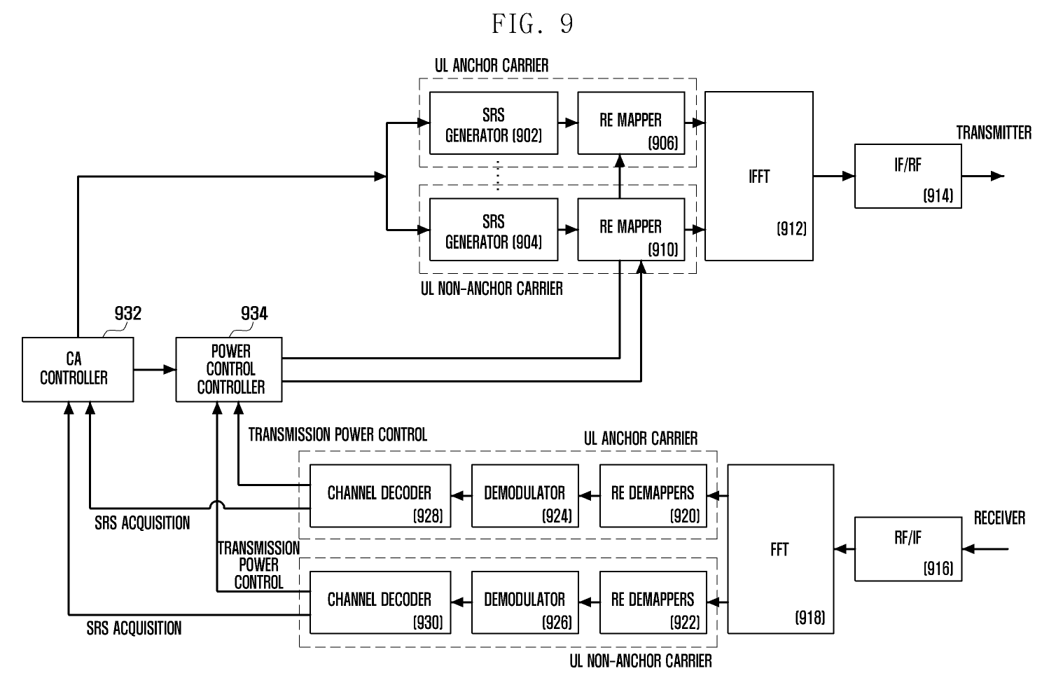

FIG. 9 is a diagram illustrating a UE apparatus according to the third embodiment of the present invention.

Referring to FIG. 9, the UE operates on the two uplink component carriers aggregated. For uplink transmission, the transmitter of the UE includes SRS generators 902 and 904 for generating Sounding Reference Signal (SRS) to be transmitted on the respective component carriers and RE mappers 906 and 908 for mapping the SRSs to Resource Elements (REs). The signals output by the RE mappers 906 and 910 responsible for the corresponding component carriers are processed by Inverse Fast Fourier Transform 912 and IF/RF unit 914 to be transmitted. Although the IFFT unit 912 and IF/RF unit 914 are depicted as common function blocks, they can be implemented per component carrier.

The receiver of the UE includes an RF/IF unit 916 for performing RF/IF signal processing on the received signal, a FFT unit 918 for performing FFT, RE demappers 920 and 922 for performing RE demapping on the corresponding component carriers, modulation mappers 914 and 926, and channel decoders 928 and 930. The RF/IF unit 916 and FFT unit 918 can be implemented per component carrier.

The carrier aggregation controller 932 acquires SRS transmission-related information from the UE receiver to determine the uplink component carrier for SRS transmission. The carrier aggregation controller 932 controls the SRS generators 902 and 904 to generate SRS to be transmitted on the uplink component carriers according to the determination result. The carrier aggregation controller 932 controls the power control controller 934 to control transmission power on the corresponding component carriers. The power control controller 934 performs transmission power control on the corresponding component carrier based on control signal of the uplink carrier aggregation controller 932 and the power control command received through the UE receiver.

Although the power control is applied to the RE mappers 906 and 910 for the respective component carriers, it can be applied to other functional devices. If the first signal transmitted by the UE on the non-anchor carrier is SRS, the power control controller 934 configures the initial SRS transmission power using equation 10. Once the SRS is transmitted on the non-anchor carrier, the power control controller 934 performs power control according to the power control command transmitted by the eNB.

The eNB apparatus according to the third embodiment is implemented in the same configuration as the eNB apparatus described with reference to FIG. 7. A brief description is made as follows.

The eNB includes an RF/IF unit for performing RF/IF processing on the received signal, an FFT unit for performing FFT processing, RE demappers responsible for RE demapping on the respective component carriers, and a PUSCH/PUCCH/SRS processor. The eNB further includes an eNB scheduler for generating scheduling grant to the UE and a scheduling information generator per component carrier for generating control information. The eNB performs channel coding, modulation, and RE mapping, IFFT signal processing, and IF/RF signal processing on the control information generated by the scheduling grant generator, and transmits the processed signal to the UE. The RF/IF unit and IFFT unit can be implemented per component carrier. The specification and drawings are to be regarded in an illustrative rather than a restrictive sense in order to help understand the present invention. It is obvious to those skilled in the art that various modifications and changes can be made thereto without departing from the broader spirit and scope of the invention.

What is claimed is:

1. An initial transmission power configuration method of a terminal in a mobile communication system transmitting/receiving data on anchor and non-anchor carriers, comprising:
configuring, when a random access process is completed on the anchor carrier, initial transmission power of the non-anchor carrier using most recent transmission power of the anchor carrier; and
transmitting data at the initial transmission power of the non-anchor carrier.

2. The method of claim 1, wherein configuring initial transmission power of the non-anchor carrier comprises compensating the most recent transmission power of the anchor carrier with sum of channel environment offset and scheduling information offset.

3. The method of claim 1, wherein configuring initial transmission power of the non-anchor carrier comprises calculating, when an uplink shared channel is transmitted on the non-anchor carrier, the initial transmission power of the non-anchor carrier according to the uplink shared channel.

4. The method of claim 1, wherein configuring initial transmission power of the non-anchor carrier comprises calculating, when an uplink control channel is transmitted on the non-anchor carrier, the initial transmission power of the non-anchor carrier according to the uplink control channel.

5. The method of claim 1, wherein configuring initial transmission power of the non-anchor carrier comprises calculating, when a sounding reference signal is transmitted on the non-anchor carrier, the initial transmission power of the non-anchor carrier according to the sounding reference signal.

6. An initial transmission power configuration apparatus comprising:
a receiver which receives a scheduling grant transmitted by a base station;
a carrier aggregation controller which determines a component carrier for transmitting data based on the scheduling grant;
a power control controller which configures, when the component carrier is a non-anchor carrier, initial transmission power of the non-anchor carrier using most recent transmission power of an anchor carrier; and
a transmitter which transmits the data at the configured initial transmission power on the non-anchor carrier.

7. The apparatus of claim 6, wherein the power control controller configures the initial transmission power of the non-anchor carrier by compensating the most recent transmission power of the anchor carrier with sum of channel environment offset and scheduling information offset.

8. The apparatus of claim 7, wherein the power control controller calculates, when an uplink shared channel is transmitted on the non-anchor carrier, the initial transmission power of the non-anchor carrier according to the uplink shared channel.

9. The apparatus of claim 7, wherein the power control controller calculates, when an uplink control channel is transmitted on the non-anchor carrier, the initial transmission power of the non-anchor carrier according to the uplink control channel.

10. The apparatus of claim 1, wherein the power control controller calculates, when a sounding reference signal is transmitted on the non-anchor carrier, the initial transmission power of the non-anchor carrier according to the sounding reference signal.
